(19) United States
(12) Patent Application Publication
(10) Pub. No.: US 2004/0028947 A1
(43) Pub. Date: Feb. 12, 2004

(54) Corrosion resistant material having high magnetic moment

(76) Inventors: Peter Kevin Mark McGeehin, Derry (IE); Alan Biggar Johnston, Derry (IE)

Correspondence Address: Intellectual Property Department NRW-097, Seagate Technology LLC, 7801 Computer Avenue South, Bloomington, MN, 55435, US

(21) Appl. No.: 10/273,212

(22) Filed: Oct. 17, 2002

(30) Foreign Application Priority Data
Aug. 8, 2002 (GB) 0218419.0

(51) Int. Cl. B32B 9/00

(52) U.S. Cl. 428/694 R

(57) ABSTRACT

The present invention is directed to a corrosion resistant ferromagnetic alloy suitable for use as write pole material in on a magnetic media recording head, as well as to magnetic media heads containing the corrosion resistant alloy. The corrosion resistant film generally includes a rhodium-containing alloy, most typically a cobalt iron rhodium alloy. The invention is further directed to methods of forming the alloy and applying it to substrates, such as magnetic media recording heads. The corrosion resistant alloy provides significant corrosion resistance while simultaneously maintaining a high magnetic moment (Bs), which facilitates high density read and write functions.

### FIELD OF THE INVENTION

The present invention is directed to materials having a high magnetic moment. In particular, the present invention is directed to materials having a high magnetic moment, which provide improved corrosion resistance, and which are suitable for use as write pole materials in magnetic media recording heads.

### BACKGROUND OF THE INVENTION

Magnetic media recording heads (which perform both reading and writing functions) operate within disc enclosures (such as hard disc drives) by detecting and modifying the magnetic properties of the surface of the hard drive. In modern hard drives the recording heads are positioned extremely close to the rotating surface of the disc on a cushion of air. Because of the high disc rotation speeds, information density, and close tolerances within the drive, great efforts have been made to assure that the interior of hard drives is extremely clean and free of contaminants. Nevertheless, some contaminants can accumulate within the drive from either the external environment or from components within the drive. For example, hydrocarbons or dust particles can enter the drive from exterior sources during heating and cooling cycles.

Many of these contaminants pose a significant problem because they can corrode the components of the drive, including the recording heads. In particular, corrosion of the write pole material of the read/write head can result in catastrophic failure of the head. This corrosion occurs, for example, during use from contaminants within the environment where the read/write head operates. In addition, corrosion can occur during formation of the recording head, including during wafer production and the cutting or slicing steps of processing a coated wafer. Thus, a need exists for the prevention of corrosion in magnetic media heads and in particular, prevention of corrosion in write pole materials.

In addition to a need to prevent corrosion of magnetic media heads, magnetic media heads with a high magnetic moment (also known as saturation induction or Bs) are often desired because a high magnetic moment facilitates the making of drives (or other magnetic media) with higher data density and higher access and record times. Materials that are known to have a particularly high magnetic moment are CoFe (cobalt iron) alloys. Unfortunately, these alloys are very susceptible to corrosion and thus have not experienced widespread use in magnetic media recording heads used in hard disc drives or other magnetic media.

Although meaningful advances have been made in hard drive components and corrosion prevention, a need remains for improved magnetic media recording heads, in particular magnetic media read heads having write pole materials with improved corrosion resistance while retaining a high magnetic moment.

### SUMMARY OF THE INVENTION

The present invention is directed to corrosion resistant ferromagnetic alloys suitable for use as a write pole material in magnetic media recording heads, for use in for example hard drives, as well as for magnetic media recording heads containing corrosion resistant alloys. The invention is further directed to methods of forming the alloys and applying them to substrates, such as to components of magnetic media recording heads. The corrosion resistant alloys provide significant corrosion resistance while simultaneously maintaining a high magnetic moment (Bs), which facilitates high density read and write functions. Also, the corrosion resistant alloys are suitable for electro-deposition, and methods of electro-deposition of the films are within the scope of the invention.

In general, the ferromagnetic alloys of the invention include an alloy of iron, cobalt, and rhodium. The rhodium can be added in a manner such that it significantly improves the corrosion resistance of the cobalt iron alloys without substantially diminishing their magnetic moment. Other materials may also be incorporated into the alloy in certain implementations of the invention.

In general the alloy contains greater than 60 weight percent iron, greater than 25 weight percent cobalt, and greater than 0.5 weight percent rhodium. In some implementations the alloy comprises at least 1.0 percent by weight rhodium, while in other implementations the alloy contains at least 2.0 percent by weight rhodium. Typically the alloy contained less than 5.0 percent rhodium. Superior performance can often be observed in alloys with less than 2.0 weight percent Rh because these alloys do not dramatically limit the magnetic moment of the film but do provide good corrosion resistance. Particularly significant benefits in terms of corrosion protection and magnetic moment are observable from alloys with about 1.0 to 2.0 percent Rhodium.

The corrosion resistant alloys of the present invention provide high magnetic moment (Bs) that approaches the magnetic moment of pure cobalt iron (CoFe) alloys. In some implementations the magnetic moment of the alloy is greater than 1.8 T, and in other implementations even greater than 1.9 T. The corrosion resistant alloy of the invention normally has a magnetic moment of at least 80 percent of the magnetic moment of a CoFe alloy not containing rhodium, and even more desirably at least about 90 percent or 95 percent of the magnetic moment of a CoFe alloy.

Although the films of the invention can be made to have varying thicknesses, they are normally at least 0.1 μm thick, and often at least 0.25 μm thick. Generally the alloys have a corrosion potential (Ec_{corr}) of greater than −300 mV and a corrosion current value (I_{corr}) of less than 13 μA/cm² in a 1.0 M solution of NaCl. In certain embodiments, the E_{corr} is greater than −250 mV and the I_{corr} is less than 10 μA/cm². Corrosion potential values of less negative numbers are more desirable, as are corrosion current values of lower positive numbers.

The corrosion resistant alloy film of the invention can be formed using various methods, including electro-deposition, sputter coating, etc. In certain desirable implementations the ferromagnetic alloy film is formed by electro-deposition because this method is cheaper to implement than sputter coating.

The above summary of the present invention is not intended to describe each disclosed embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a chart depicting the magnetic moment of various RhCoFe alloys made in accordance with the invention.

FIG. 2 is a chart depicting the corrosion potential of RhCoFe alloys made in accordance with the invention.

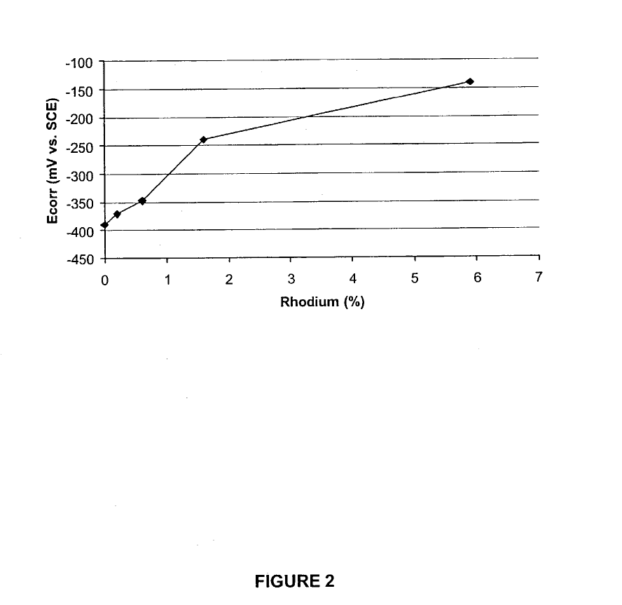

FIG. 3 is a second chart depicting corrosion current of RhCoFe alloys made in accordance with the invention.

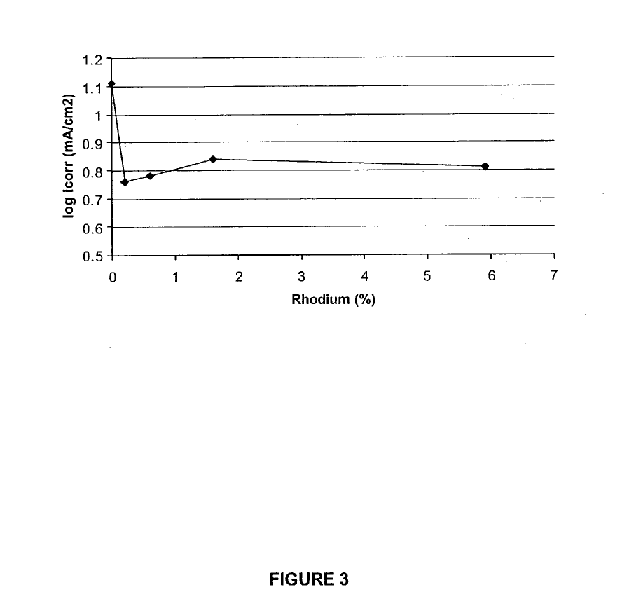

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

Detailed Description

The present invention is directed to a corrosion resistant ferromagnetic alloy suitable for use as write pole material in a magnetic media recording head, as well as to magnetic media recording heads containing the corrosion resistant alloy. The invention is further directed to methods of forming the alloy and applying it to substrates, such as magnetic media heads. The corrosion resistant alloy provides significant corrosion resistance while simultaneously maintaining a high magnetic moment (Bs). The corrosion resistance is advantageous because it avoids deterioration in the drive head during manufacture or during use, while the high magnetic moment facilitates the production of high density drives that have superior performance features.

The alloy of the invention is a ferromagnetic alloy that includes cobalt, iron and rhodium. Other materials may also be incorporated into the alloy in certain implementations of the invention. The relative ratios of the iron, cobalt, and rhodium are normally selected so as to preserve a high magnetic moment while still obtaining useful corrosion resistance compared to other materials. In general the ferromagnetic alloy contains at least about 60 weight percent iron, at least about 25 weight percent cobalt, and at least about 0.5 weight percent rhodium. Normally significantly higher levels of iron are present and somewhat higher levels of cobalt are present. Higher levels of rhodium are also possible, but these levels are still generally kept below about 5 percent of the total alloy content by weight. In some implementations, the alloy comprises at least 1.0 percent by weight rhodium, while in other implementations the alloy contains at least 2.0 percent by weight rhodium.

Thus, alloys made in accordance with the invention can be formed with various relative ratios of cobalt, iron, and rhodium. Typically, iron is the most common ingredient, with lower levels of cobalt and much lower levels of rhodium. In one example embodiment, the ratios are greater than about 65 percent by weight iron, greater than about 25 percent by weight cobalt, and less than 3 percent by weight rhodium. Generally, the iron percent by weight is from 60 to 80 percent of the alloy, frequently from about 65 to about 75 percent of the alloy, even more frequently from about 67 to 72 percent of the alloy. The amount of cobalt is usually from about 25 to 35 percent by weight, and frequently from about 27 to 30 percent by weight cobalt. The amount of rhodium normally is below 5% by weight, even more commonly below 3 percent by weight, and even more commonly below 2 percent by weight of the total alloy. In some implementations rhodium is about 1.0 to 2.0 percent by weight of the alloy.

It is often desirable that the iron levels be maintained at high levels, preferably approaching the 72 percent iron and 28 percent cobalt that is common in pure cobalt iron alloys. However, it has been observed that the presence of rhodium in the plating bath results in a decrease in the Fe:Co ratio in the deposited film i.e., the phenomenon of anomalous codeposition is less pronounced. In anomalous codeposition, the less noble metal (in this case Fe) is deposited preferentially to the more noble metal (in this case Co). The ratio of Fe:Co in the deposited film is much higher than the corresponding ratio of metal salts in the plating bath. For example, the addition of about six percent rhodium can result in the level of electrodeposited iron drops from about 72 percent to about 62 percent while the amount of cobalt rises from about 28 to 32 percent. In certain specific implementations the alloy makeup is about 66 percent iron, about 32 percent cobalt, and about 2 percent rhodium. In some implementations the amount of cobalt is actually higher than it would be if no rhodium were used (such as a pure iron cobalt alloy).

The corrosion resistant alloy of the present invention provides a high magnetic moment (Bs) that approaches the magnetic moment of pure iron cobalt alloys. The theoretical maximum magnetic moment of bulk iron cobalt alloys as described herein is about 2.45 Tesla, but to date in electrodeposition it is more common to get a magnetic moment somewhat less than this value for pure cobalt iron alloys (approximately 2 Tesla). In comparison, some implementations of the invention provide for an alloy of iron, cobalt, and rhodium having a magnetic moment that is very close to the magnetic moment of rhodium-fee iron cobalt alloys, in some cases approaching exceeding 1.9 T or 1.95%. Usually, the magnetic moment of alloys made in accordance with the invention is greater than 1.8 T, and even greater than 1.9 T.

The magnetic moment measurement of a material can vary depending upon how the measurement is made. Thus, the relative magnetic moment of the alloy film compared to pure cobalt iron alloy films is a useful indication because it uses pure cobalt iron as a standard and uses the same test to measure the magnetic moment of both the alloy film and the cobalt iron standard. The corrosion resistant film of the invention normally has a magnetic moment of at least 80 percent of the magnetic moment of a pure iron cobalt film that does not contain rhodium, and even more commonly a magnetic moment of at least 90 percent of pure iron cobalt. Specific implementations have a magnetic moment of greater than 95 percent of that of pure iron cobalt, and some approach or exceed even about 99 percent of pure iron cobalt.

The alloy of the present invention is typically used as the write pole material of a magnetic media recording head, and therefore it should be thick enough to provide adequate magnetic flux to the media when writing. As noted above, in most implementations the alloy has a magnetic moment very close to the high levels observed by CoFe alloys, and any diminishment of magnetic moment is generally not a significant problem. Although the film can be made to have varying thicknesses, it is normally at least 0.1 microns thick, more typically at least 0.2 microns thick, and often from about 0.2 to 0.5 microns thick. However, various thicknesses that are less or more than these dimensions are appropriate for some implementations.

The alloys and alloy films of the present invention provide significant advantages in terms of corrosion resistance improvement of the magnetic media recording head. Two relevant measurements of corrosion resistance are the corrosion potential (E_{corr}) and corrosion current (I_{corr}) of the film. High values (less negative) for the E_{corr} are preferred, while low current I_{corr} values are also desired. Generally the film has a corrosion potential (E_{corr}) of greater than −300 mV and a corrosion current value (I_{corr}) of less than 15 μA/cm² in a 1.0 M solution of NaCl. In some implementations, the E_{corr} is greater than −250 mV, and even greater than −200 mV. The I_{corr} value can be, for example, below 10 μA/cm², and even more desirably below 8 μA/cm².

The corrosion resistant alloy or film of the present invention can be formed using various methods, including electro deposition, sputter coating, etc. In certain desirable implementations the ferromagnetic alloy film is formed by electro-deposition. Suitable electro-deposition can be performed in a liquid environment containing metal salt sulfates of the three elements used in the alloy. For example, the bath can contain from 0.01 to 0.1 M of Fe⁺², 0.01 to 0.1 M Co⁺², and 10⁻⁶ to 10⁻⁴ M Rh⁺³. Those skilled in the art will appreciate the need for such small concentrations of noble metal (rhodium) salts compared to cobalt and iron. When one looks at the electrochemical properties of the metals involved, one can obtain some understanding of the processes involved. For example, comparison of the standard reduction potentials (E⁰) of rhodium, cobalt and iron shows Rh is a high positive value (0.76V) compared to both Co (−0.28V) and Fe (−0.44V). Rhodium is said to be the more noble of the three metals. Application of current to a simple sulfate solution of these ions results in Rh being deposited first, due to the fact that the potential of the Rh reduction reaction is the most positive. The exclusive reduction of Rh will continue until there is a voltage drop at the cathode. This voltage drop can be achieved if the rate of the Rh reduction reaction becomes diffusion limited and a high enough current is applied. When the applied current exceeds the diffusion limiting current of the Rh reduction reaction, the result is a build-up of charge at the cathode. This excess negative charge lowers the potential of the cathode to a voltage range within which lies the E⁰'s of both Co and Fe reduction. It is at this point that all three metals can be reduced simultaneously to form ternary alloys of RhCoFe. Using a very low concentration of Rh⁺³ in the solution causes the rate of the Rh reduction reaction to become diffusion limited more quickly at relatively low applied currents. It is for this reason that the concentrations of Rh⁺³ salts in the bath are kept so small compared to the concentration of both Fe⁺² and Co⁺² salts.

Other electro-deposition bath ingredients can include, for example, ammonium chloride (about 5 to 20 grams per liter), boric acid (about 10 to 30 grams per liter), sodium lauryl sulfate (about 0.01 to 2 grams per liter), and sodium saccharin (0.01 to 2 grams per liter). The pH is typically maintained at an acid level, below ph 4.0, commonly pH below 3.0, acceptably a pH about 2.8. The current applied (1 to 20 mA/cm²) is from a DC power supply.

### EXAMPLES

The invention will now be described in reference to the following examples. These examples are provided for illustrative purposes. The substrates used were AlTiC wafers deposited with alumina. Each of these wafers were then vacuum deposited with a thin conductive film of copper (1000 Angstroms), which acts as the seedlayer for the electroplated material. The alloy samples were then electrodeposited onto the substrates. Table 1 shows the affect varying the amount of rhodium has on magnetic moment (Bs), particularly in comparison to the magnetic moment of pure cobalt iron alloys.

TABLE 1

| | | | Percent Bs |
|---|---|---|---|
| | | Magnetic | compared to |
| Sample | % Rh | Moment (T) | pure CoFe |
| 1 | 0.0 | 2.00 | 100 |
| 2 | 0.2 | 1.98 | >99 |
| 3 | 0.6 | 1.98 | >99 |
| 4 | 1.6 | 1.97 | >99 |
| 5 | 2.6 | 1.80 | 90 |
| 6 | 5.9 | 1.70 | 85 |

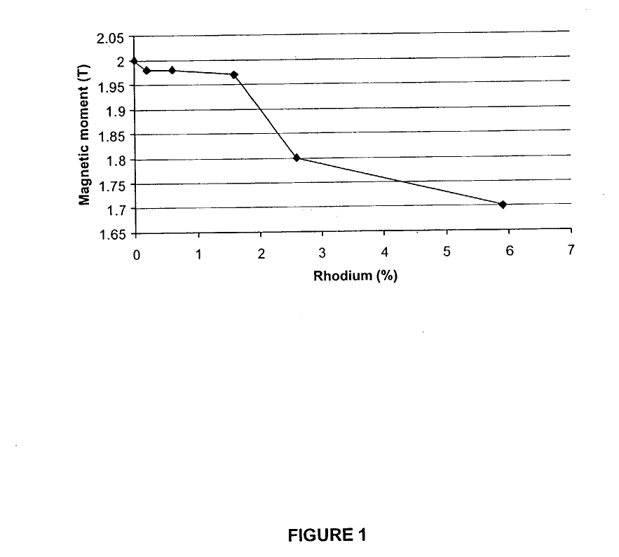

Table 1 shows that the maximum magnetic moment is obtained with a pure cobalt iron alloy. The theoretical maximum magnetic moment of cobalt iron alloys is approximately 2.45 T. However, lower magnetic moment values were observed in this experiment than the theoretical maximum. However, using the same protocol, the material having low levels of rhodium demonstrated high magnetic moment values that approached those of the pure cobalt iron alloys. Thus, small amounts of rhodium can be added to the cobalt iron alloy without significant deterioration of the magnetic levels. As the amount of rhodium added to the alloy increases, the magnetic moment diminishes. This diminishment is very gradual until approximately 1.6 percent rhodium has been added, after which magnetic moment drops more rapidly. Thus, the alloy with 1.6 percent rhodium has a magnetic moment just 1.5 percent less than that of the rhodium-free cobalt iron alloy. These results are also shown in FIG. 1.

The corrosion performance of various alloys made in accordance with the invention were also measured. The corrosion potential (E_{corr}) and corrosion current (I_{corr}) values for cobalt iron (CoFe) alloys and various cobalt iron rhodium (CoFeRh) alloys were measured in two solutions; an electrolyte solution of 0.1 M NaCl having a pH of approximately 5.9 and a plating solution having a pH of 2.8. The 0.1 M NaCl solution was selected to simulate some of the wet-chemistry environments encountered by a read write head during manufacture, and is also used to mimic conditions of humidity when drives are being tested. The plating solution was used to reproduce some of the harsher wet-processes the read write head is exposed to during manufacture.

The corrosion tests were carried out using a Gamry Potentiostat. The electrochemical cell was an EG&G flat cell (available from Princeton Applied Research) onto which a wafer was clamped to expose 1 cm² of a metal film to approximately 300 ml of solution. All the solutions were used in their naturally aerated state and they were quiescent (unstirred). Scans of metal film potential relative to a standard SCE (saturated calomel electrode) versus log (current density) were carried out at 0.5 mV per second. The scans were started after the films were exposed to the solutions and the potential reached a stable value.

The corrosion current densities I_{corr} were determined by computer Tafel analyses. I_{corr} values are proportional to the corrosion rates and should be taken as order of magnitude determinations. The E_{corr} value in a solution is the potential of the metal film versus an SCE with no net current flowing. The corrosion potential (E_{corr}) and corrosion current (I_{corr}) values for CoFe and various CoFeRh alloys measured in 0.1M NaCl solution are given in Table 2.

TABLE 2

| | Percent | E_{corr} | I_{corr} | log I_{corr} |
|---|---|---|---|---|
| Sample | Rhodium | (mV vs. SCE) | (μamps/cm²) | (μamps/cm²) |
| 1 | 0 | −390 | 13 | 1.11 |
| 2 | 0.2 | −371 | 5.8 | 0.76 |
| 3 | 0.6 | −348 | 6 | 0.78 |
| 4 | 1.6 | −240 | 6.9 | 0.84 |
| 5 | 5.9 | −140 | 6.5 | 0.81 |

As indicated in Table 2, the corrosion resistance of the cobalt iron rhodium alloys greatly increased over the pure cobalt iron alloys. The least negative E_{corr} values of CoFeRh alloys mean a greater resistance to the onset of corrosion, and the smaller values of I_{corr} and log I_{corr} correspond to the lower corrosion rates of these alloys.

The corrosion potential (E_{corr}) and corrosion current (I_{corr}), values for CoFe and various CoFeRh alloys were also measured in a plating bath solution having a pH of 2.8. The results of this testing is provided below in Table 3.

TABLE 3

| | Percent | E_{corr} | I_{corr} | log I_{corr} |
|---|---|---|---|---|
| Sample | Rhodium | (mV vs. SCE) | (μamps/cm²) | (μamps/cm²) |
| 6 | 0 | −529 | 13 | 0.95 |
| 7 | 1.6 | −525 | 8 | 0.9 |
| 8 | 5.9 | −535 | 8 | 0.9 |

Although the improvements in E_{corr}, are not as dramatic as in the previous case, there is again an improvement in the I_{corr} values when Rh is present in the alloys. These experiments demonstrate beneficial electrodeposited rhodium-containing cobalt iron alloys can be created using very small amounts of rhodium without excessively diminishing magnetic moment and while still significantly improving corrosion resistance.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

1. A corrosion resistant ferromagnetic film suitable for use on a magnetic media head, the ferromagnetic film comprising:
(a) at least 65 weight percent iron;
(b) at least 28 weight percent cobalt; and
(c) at least 0.5 percent by weight rhodium.

2. The ferromagnetic alloy film of claim 1, wherein the film comprises at least 1.0 percent by weight rhodium.

3. The ferromagnetic alloy film of claim 1, wherein the film comprises from 1.0 to 2.0 percent by weight rhodium.

4. The ferromagnetic alloy film of claim 1, wherein the film has a magnetic moment of at least 1.8 T.

5. The ferromagnetic alloy film of claim 1, wherein the film has a magnetic moment of at least 90 percent of a CoFe film not containing rhodium.

6. The ferromagnetic alloy film of claim 1, wherein the film is at least 0.1 μm thick.

7. The ferromagnetic alloy film of claim 1, wherein the film is formed by electrodeposition.

8. The ferromagnetic alloy film of claim 1, wherein the film has a E_{corr} of greater than −350 mV and an I_{corr} of less than 10 μA/cm² in a 1.0 M solution of NaCl.

9. The ferromagnetic alloy film of claim 1, wherein the film has an E_{corr} of greater than −300 mV and an I_{corr} of less than 8 μA/cm² in a 1.0 M solution of NaCl.

10. An electro-deposited corrosion resistant ferromagnetic alloy suitable for use as write pole material in a magnetic media recording head, the ferromagnetic alloy comprising:
(a) at least 68 weight percent iron;
(b) at least 28 weight percent cobalt; and
(c) from about 1.0 to 2.0 percent by weight rhodium;
wherein the film has an E_{corr} of greater than about −350 mV, an I_{corr} of less than 8 μA/cm², and a magnetic moment of at least 90 percent of that of a substantially pure iron cobalt ferromagnetic film.

11. The electro-deposited corrosion resistant ferromagnetic alloy of claim 10, wherein the film is at least 0.1 micron thick.

12. The electro-deposited corrosion resistant ferromagnetic alloy of claim 10, wherein the film is at least 0.5 percent rhodium.

13. The electro-deposited corrosion resistant ferromagnetic alloy of claim 10, wherein the film has an E_{corr} of greater than about −300 mV, an I_{corr} of less than 6 μA/cm², and a magnetic moment of at least 95 percent of that of a substantially pure iron cobalt ferromagnetic film.

14. A method of forming a corrosion resistant ferromagnetic alloy, the method comprising:
providing a substrate;
electrodepositing onto the substrate a corrosion resistant ferromagnetic layer having at least 68 weight percent iron, at least 28 weight percent cobalt, and at least 0.5 percent by weight rhodium.

15. The method of claim 14, wherein the corrosion resistant ferromagnetic layer has an E_{corr} of greater than about −300 mV.

16. The method of claim 14, wherein the corrosion resistant ferromagnetic layer has an I_{corr} of less than 10 μA/cm².

17. The method of claim 14, wherein the corrosion resistant ferromagnetic layer has a magnetic moment of at least 95 percent of that of a substantially pure cobalt iron ferromagnetic film.

18. The method of claim 14, wherein the corrosion resistant ferromagnetic layer comprises from about 1.0 to 2.0 percent by weight rhodium.

19. A magnetic media head comprising:
a corrosion resistant ferromagnetic write pole comprising at least 68 weight percent iron, at least 28 weight percent cobalt, and at least 0.5 percent by weight rhodium.

20. The magnetic media head of claim 19, wherein the write pole material has an E_{corr} of greater than about −350 mV, an I_{corr} of less than 8 μA/cm², and a magnetic moment of at least 90 percent of that of a substantially pure iron cobalt ferromagnetic film.

21. The magnetic media head of claim 19, wherein the film is at least 0.1 micron thick.

22. The magnetic media head of claim 19, wherein the film is at 0.5 percent rhodium.
